(19) United States
(12) Patent Application Publication
(10) Pub. No.: US 2012/0069486 A1
(43) Pub. Date: Mar. 22, 2012

(54) FABRIC CONNECTOR FOR SENSING OBJECT PROXIMITY

(75) Inventors: James Lee, Taipei (TW); Hong hsu Huang, Taipei (TW)

(73) Assignees: KINGS METAL FIBER TECHNOLOGIES CO., LTD., TAIPEI (TW); TEX-RAY INDUSTRIAL CO., LTD, TAIEPI (TW)

(21) Appl. No.: 13/321,943

(22) PCT Filed: Jun. 8, 2009
(86) PCT No.: PCT/CN09/72174

§ 371 Date: Nov. 22, 2011

(51) Int. Cl. H01G 4/00

(52) U.S. Cl. 361/301.1

(57) ABSTRACT

A fabric connector for sensing object proximity is provided. The fabric connector comprises a sensing layer (23), an insulating layer (22) and a yarn (26). The sensing layer has at least one connection region (233a, 233b, 233c, 233d) and a disconnection region. The at least one connection region (233a, 233b, 233c, 233d) has a capacitance value and is formed with conductive fabric. The insulation layer (22) which is formed with insulating fabric is disposed below the sensing layer (23). The yarn (26) is formed with conductive material and is configured to electrically connect to the at least one connection region (233a, 233b, 233c, 233d) of the sensing layer (23) and a sensor (25). The sensor (25) senses a variation in the capacitance value of the at least one connection region (233a, 233b, 233c, 233d) in accordance with object proximity.

### CROSS-REFERENCES TO RELATED APPLICATIONS

Not applicable.

### BACKGROUND OF THE INVENTION

1. Field of the Invention

The present invention relates a fabric connector for sensing object proximity. More specifically, the present invention relates a fabric connector for sensing object proximity without a substantial touch in accordance with a capacitor structure.

2. Descriptions of the Related Art

As technology progress, people have become in need of electronic products (e.g. mobile phones, PDA, MP3 etc.) and carry them around in daily life. It makes perfect sense to actually integrate these electronic products into clothing since clothing is just like the second skin to people, and such technology is referred as a smart closing.

Typically, smart closing employs fabric connectors for users to control electronic products, it means that fabric connectors are embed with clothing and are electrically connected to electronic products. FIG. 1 depicts a cross sectional view of a conventional fabric connector 1, which comprises conductive studs 11, 12, fabric portions 13, 14, and resilient space components 15, 16. The conductive studs 11, 12 are mounted inside the fabric portions 13, 14 respectively, wherein the fabric portions 13, 14 might be a portion of a garment.

The conductive studs 11, 12 are electrically connected to an electronic product (not shown) and act like a switch. For example, say the conductive studs 11, 12 are electrically connected to an LED light, the conductive studs 11, 12 are normally spaced by the resilient space components 15, 16, so that the circuit of the LED light is cut and the LED light is off. When a user provides sufficient force F to the conductive stud 11 for allowing the conductive studs 11, 12 to contact each other physically, the circuit is therefore closed and the LED light is on. It is not hard to tell that the fabric connector 1 is critical for smart clothing.

Unfortunately, because the fabric connector 1 requires the sufficient force F for the conductive studs 11, 12 to contact each other, this is however not convenient for operation. Besides, the resilient space components 15, 16 may lose their resilience as time goes by and further affect the performance of the fabric connector 1.

In view of this, it is important to provide a fabric connector that is easy for operation and the life time of the fabric connector is able to prolong.

### SUMMARY OF THE INVENTION

The primary objective of this invention is to provide a fabric connector for sensing object proximity, which comprises a sensing layer, an insulation layer and a yarn. The sensing layer has at least one connection region and a disconnection region. The at least one connection region of the sensing layer has a capacitance value and is formed with conductive fabric, and the disconnection region of the same is formed with insulating fabric. The insulation layer which is formed with the insulating fabric is disposed below the sensing layer. The yarn is formed with conductive material and is configured to electrically connect to the connection region of the sensing layer and a sensor. The sensor senses a variation in the capacitance value of the at least one connection region in accordance with the object proximity.

Accordingly, the fabric connector of the present invention can sense the object proximity or the substantial touch in accordance with the capacitor structure described above, so that the fabric connector of the present invention is much easier to operate for user and the life time of the fabric connector of the present invention is longer compared to that of the prior art.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a cross sectional view illustrating a conventional fabric connector; FIGS. 2A˜2E are schematic views illustrating a preferred embodiment of the present invention;

FIGS. 3A˜3B are schematic views illustrating conductive fabric of fabric connector of the preferred embodiment;

FIG. 3C is a schematic view illustrating insulating fabric of fabric connector of the preferred embodiment; and

FIG. 4 is a top view illustrating another preferred embodiment of the present invention.

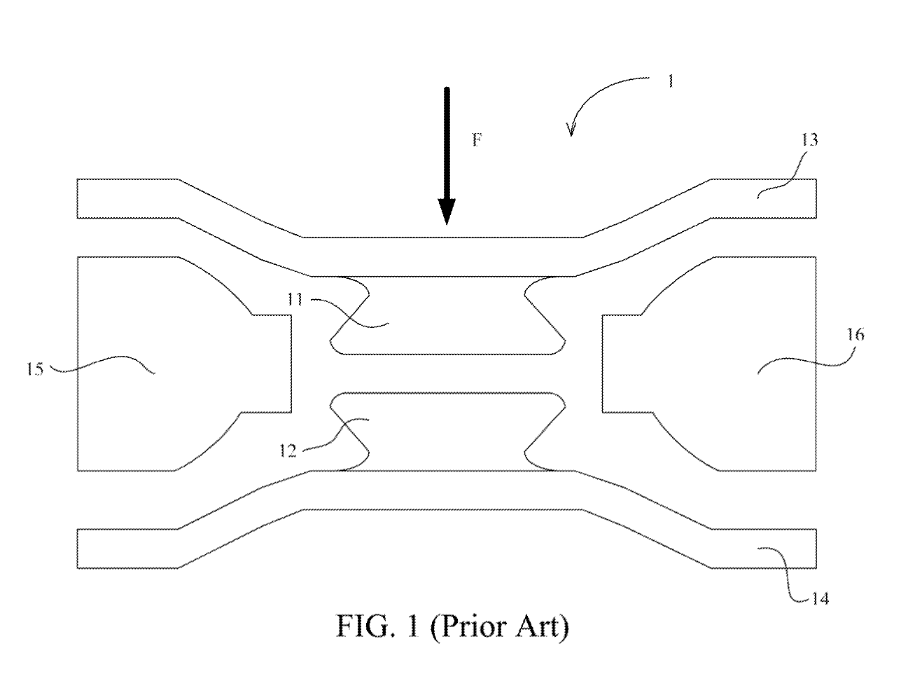

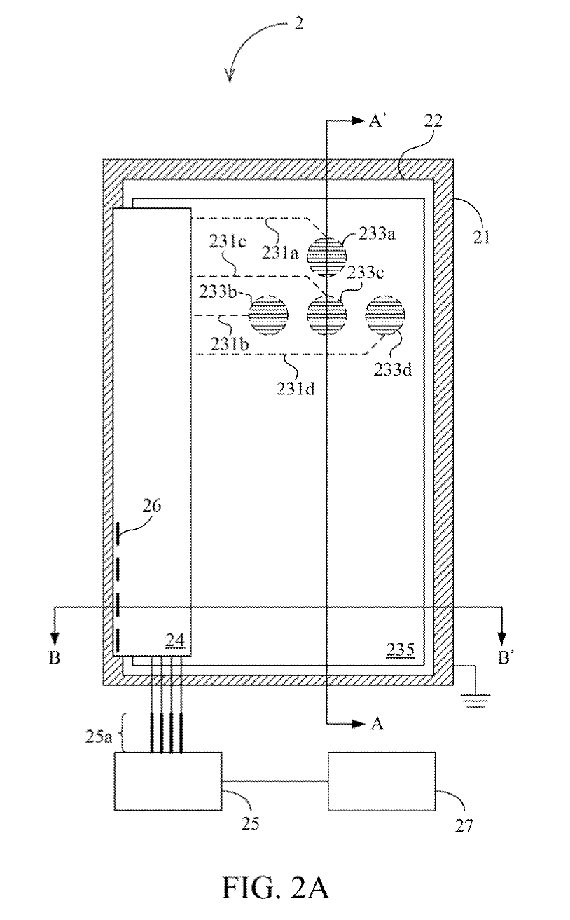

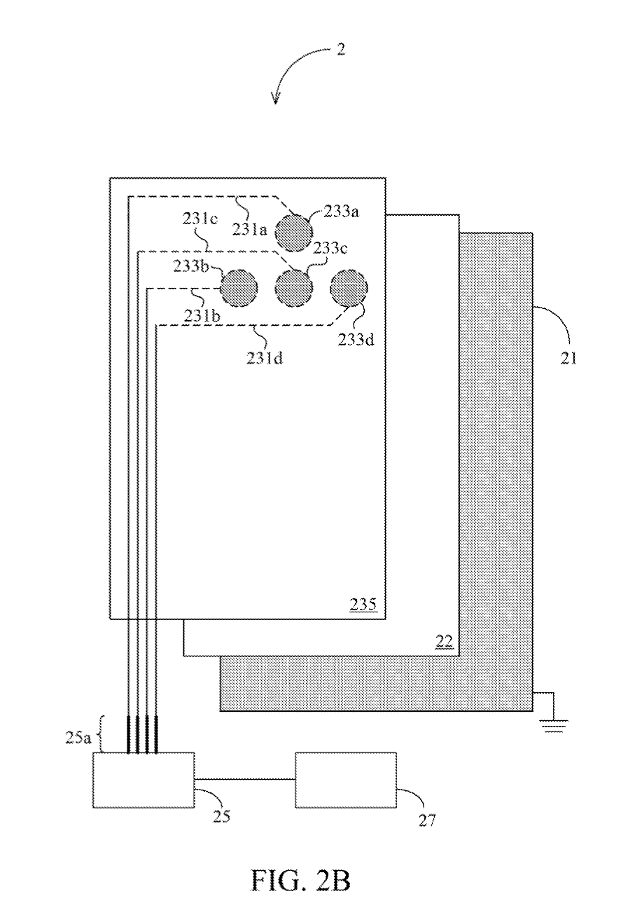

### DESCRIPTION OF THE PREFERRED EMBODIMENT

In the following description, this invention will be explained with reference to embodiments thereof. However, these embodiments are not intended to limit this invention to any specific environment, applications or implementations described in these embodiments. Therefore, description of these embodiments is only for purposes of illustration rather than to limit the present invention. It should be appreciated that in the following embodiments and the attached drawings, the elements not related directly to this invention are omitted from depiction.

FIGS. 2A˜2E are schematic views of a fabric connector 2 in accordance with a preferred embodiment of the present invention. More specifically, FIG. 2A is a top view of the fabric connector 2, FIG. 2B is an exploded view of different layers of the fabric connector 2, FIG. 2C is another exploded view of different layers of the fabric connector 2, FIG. 2D is a cross sectional view of the fabric connector 2 in accordance with A-A′, and FIG. 2D is a cross sectional view of the fabric connector 2 in accordance with B-B′.

The fabric connector 2 comprises a first layer 21, an insulation layer 22, a sensing layer 23, a plurality of first yarns 231a˜231d, a second layer 24 and a second yarn 26. The sensing layer 23 comprises a plurality of connection regions 233a˜233d, a disconnection region and a protection sub-layer 235. More specifically, the protection sub-layer 235 is disposed on the connection regions 233a˜233d and the disconnection region to protect the connection regions 233a˜233d and the disconnection region not to be damaged from the outside environment.

The connection regions can be a lot of buttons for controlling a device 27 (e.g. a MP3 player) via a sensor 25 (e.g. a sensing IC), wherein the sensor 25 is electrically connected to the device 27. To be simplified, there are four connection regions 233a˜233d for illustration. For example, the connection region 233a is illustrated a stop button for music controlling, the connection region 233b is illustrated a reverse button for music controlling, the connection region 233c is illustrated a play button for music controlling, and the connection region 233d is illustrated a fast forward button for music controlling. The sensor 25 has a plurality of external pins 25a. The connection regions 233a˜233d of the sensing layer 23 are electrically connected to the external pins 25a of the sensor 25 via the first yarns 231a˜231d, respectively.

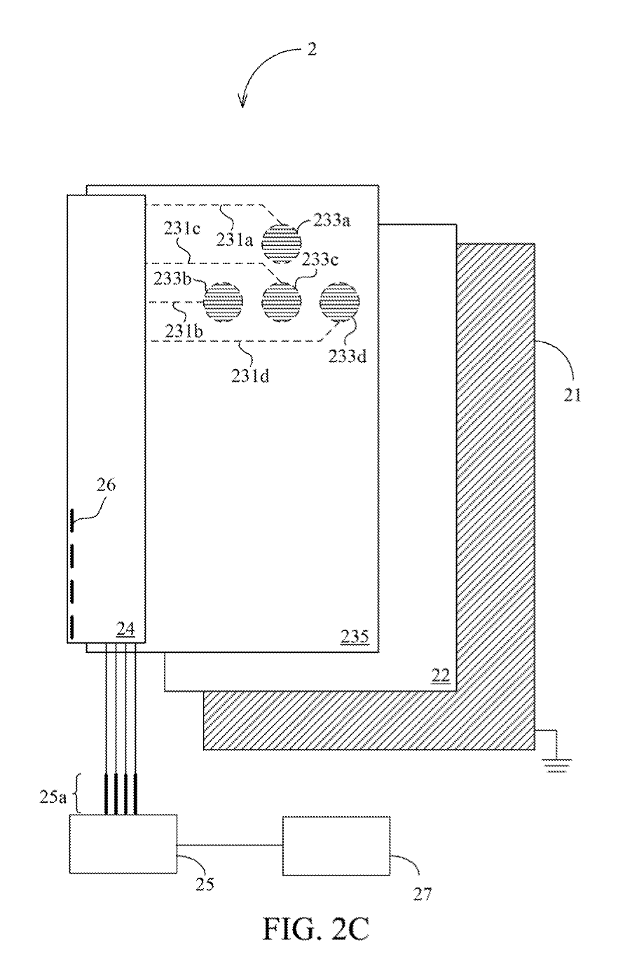

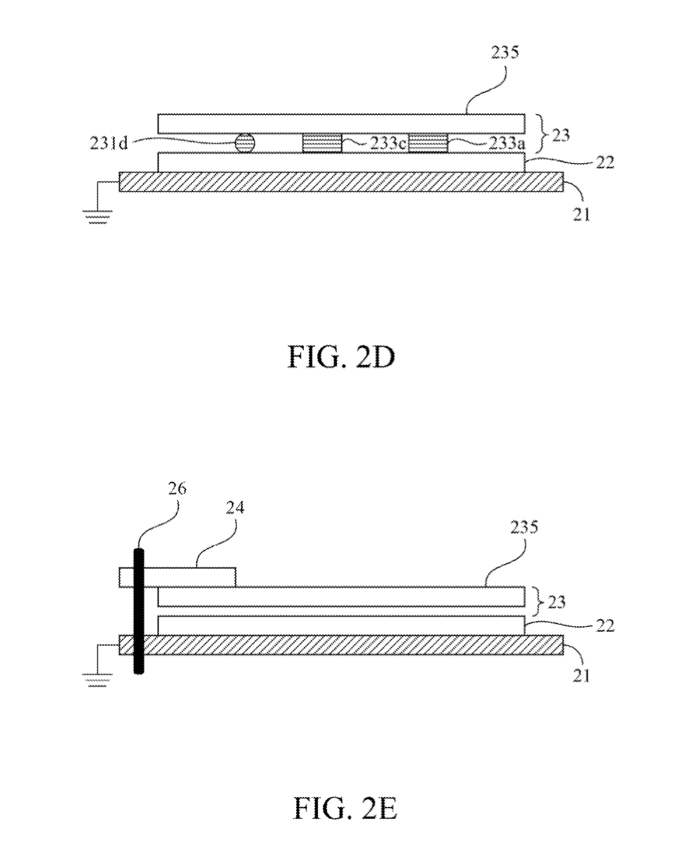

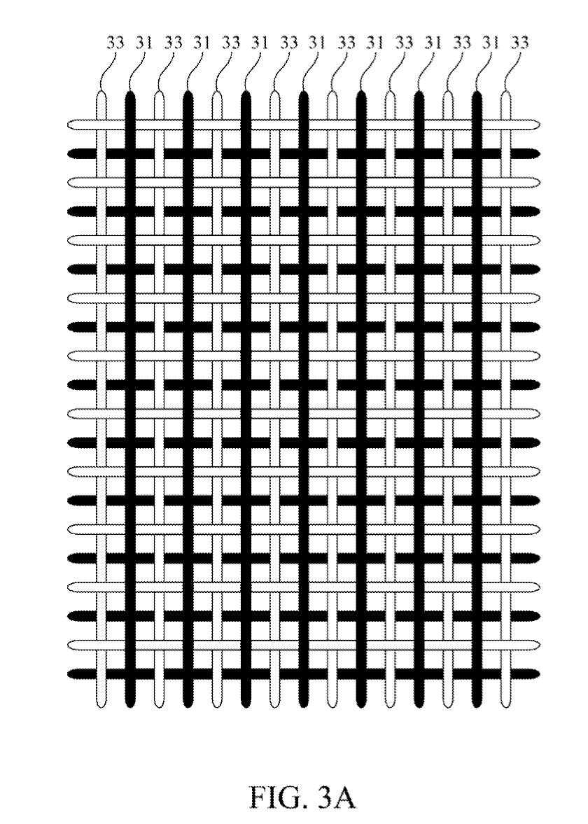

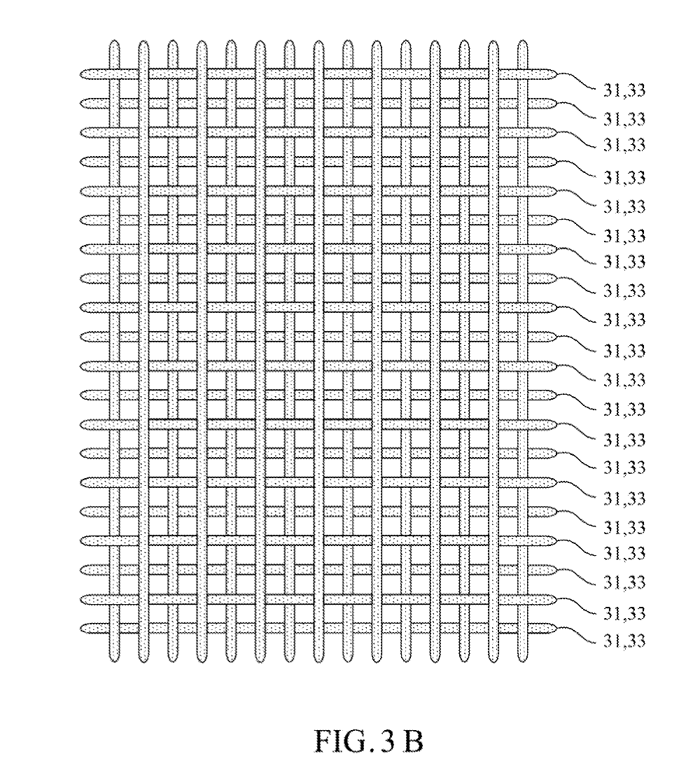

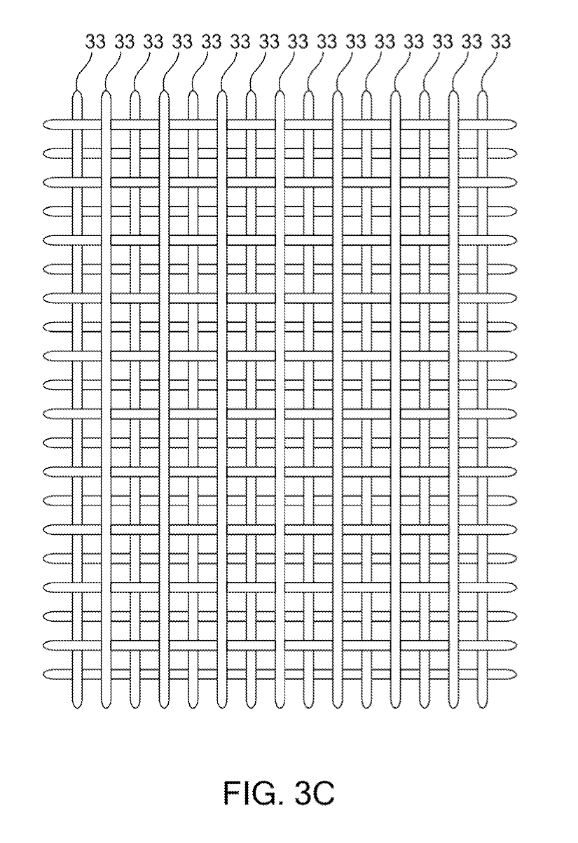

The first layer 21 and the second layer 24 are both formed with conductive fabric and are connected, linked or stapled by conductive material, e.g. the first layer 21 and the second layer 24 are sewed together by the conductive second yarn 26. As shown in FIG. 3A, the conductive fabric can be woven with a plurality conductive fibers 31 and insulating fibers 33. More specifically, the conductive fibers can be metal fibers with electric conductivity (e.g. stainless steel fibers, carbon fibers or sputtered silver), and the insulating fibers can be conventional fibers without electric conductivity (e.g. polyester, PET, cotton fibers or pure polyurethane polymer fibers). Similarly, the connection regions 233a˜233d, are woven with the conductive fibers 31 and insulating fibers 33 shown in FIG. 3A. On the other hand, the first yarns 233a˜233d and the second yarn 26 may be formed with conductive fibers 31.

It should be noted that the conductive fabric, the first yarns 233a˜233d, and the second yarn 26 may be made of any material as long as they are conductive. For example, besides woven with the conductive fibers 31 and the insulating fibers 33 as shown in FIG. 3A, the conductive fabric may be woven with only conductive fibers 31, or be woven with blended yarns comprising conductive fibers 31 and insulating fibers 33 as shown in FIG. 3B. The conductive fabric can even be made of fabric coated with conductive material such as conductive ink, carbon powder, carbon nanotube or sputtered metal, etc. Similarly, the first yarns 233a˜233d and the second yarn 26 may be made of only conductive fibers 31, be blended with the conductive fibers 31 and the insulating fibers 33, or be made of fabric coated with conductive material. It should be emphasized that mentioned material is only for illustration, not to limit the present invention.

On the other hand, the insulation layer 22 and the protection sub-layer 235 of the sensing layer 23 are both formed with insulating fabric (or other insulating material, film and membrane). As shown in FIG. 3C, the insulating fabric can be woven with a plurality of insulating fibers 33.

The critical point of the present invention is to provide at least one capacitor structure which comprises the layers described above. More specifically, the external pins 25a of the sensor 25 are an end of a capacitor, and the sensing layer 23 is one end of another capacitor, wherein each of the external pins 25a of the sensor 25 and each connection region 233a˜233d has an induced capacitance value.

According to the capacitor structures, the sensor 25 are able to sense a variation in the capacitance value of each of the external pins 25a or each of the connection regions 233a˜233d in accordance with object proximity (e.g. a finger of a user), and to transmit a signal to the device 27. More specifically, a voltage (e.g. 0 V) is provided to the first layer 21, and according to the second yarn 26, the first layer 21 and the second layer 24 will have a same electric potential (i.e. 0 V).

The sensor 25 provides a non-zero electrical potential which induces the connection regions 233a˜233d to form static charges on them, so that when the user's finger is close to one of the connection regions 233a˜233d (e.g. the connection region 233c), the electrical charge volume will be induced to change the capacitance value when the user's finger getting closer or even contacting with the one of the connection regions 233a˜233d. Similarly, the sensor 25 can sense the variation in the capacitance value of each of the external pins 25a when a user's finger touches one of the external pins 25a and the electrical charge will be drained by the user's finger to make the capacitance value changed.

Hence, the sensor 25 senses the variation in the capacitance value of each of the connection regions 233a˜233d or each of the external pins 25a, and further transmits a signal to the device 27 to inform the device 27a of button being pressed. Additionally, since the second layer 24 is disposed above the insulating layer 22 and disposed on a portion of the disconnection region of the sensing layer 23, it can shield other inference to the signal from other noise signals. In other embodiments, the first layer 21 and the second layer 24 are formed with insulating fabrics having enough thickness to shield other interference.

Accordingly, assume that the connection region 233c is illustrated the play button for music controlling, when the finger of the user (or other object) is close to the connection region 233c, after the sensor 25 senses object proximity and transmits the signal to the device 27, the device 27 will start to play music.

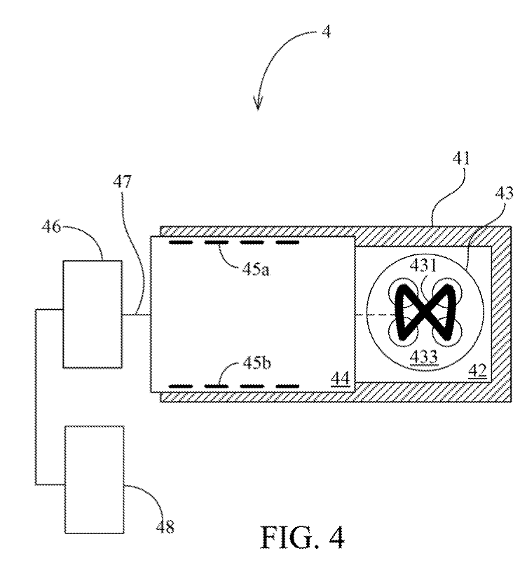

FIG. 4 is a top view of a fabric connector 4 in accordance with another preferred embodiment of the present invention. The fabric connector 4 comprises a first layer 41, an insulation layer 42, a regular garment button 43, a second layer 44 and a plurality of yarns 45a, 45b. The same as the above description, the first layer 41 and the second layer 44 are both formed with the conductive fabric and are sewed together by the yarns 45a, 45b. The regular garment button 43 comprises a connection region 431 and a disconnection region 433. The connection region 431 is electrically connected to a sensing IC 46 via a conductive yarn 47, and the sensing IC 46 is electrically connected to a device 48. Preferably, there may be two insulation materials (not shown) disposed above and below the insulation layer 42 respectively to further avoid inferences from unintentional contact.

Once the user's finger is close to, or even touch to, the regular garment button 43, the sensing IC 46 senses a variation in the capacitance value of the connection region 431 of the regular garment button 43 in accordance with the object proximity (e.g. the finger of the user) and transmits a signal to the device 48.

It should be noted that any fabric connectors 2 and 3 of the present invention can be widely applied and is not limited for smart clothing. For example, the fabric connectors 2 and 3 can be embed within sofa arm rest for lamp switch, TV control, or even combined with other furniture having fabric material. Or, the fabric connectors 2 and 3 can unitize as fabric musical instrument keys (such as a piano, drum, guitar etc.) on garment, so that the garment may make different sounds or music according to the fabric connectors 2 and 3.

Accordingly, the fabric connector of the present invention is able to sense object proximity utilizing capacitor structure. The fabric connector of the present invention does not require a sufficient force and the life time is even longer than that of the prior art. Hence, the problem of the prior art is overcome.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A fabric connector for sensing an object proximity, comprising:
a sensing layer having at least one connection region and a disconnection region, wherein the at least one connection region has a capacitance value and is formed with conductive fabric;
an insulation layer disposed below the sensing layer, wherein the insulation layer is formed with the insulating fabric; and
a first yarn, formed with conductive material, being configured to electrically connect to the at least one connection region of the sensing layer and a sensor;
wherein the sensor senses a variation in the capacitance value of the at least one connection region in accordance with the object proximity.

2. The fabric connector of claim 1, wherein the sensing layer further comprises:
a protection sub-layer disposed on the at least one connection region and the disconnection region;
wherein the protection sub-layer is formed with the insulating fabric.

3. The fabric connector of claim 1, further comprising:
a first layer formed with conductive fabric and disposed below the insulation layer.

4. The fabric connector of claim 3, further comprising:
a second layer formed with the conductive fabric;
wherein the second layer is disposed on a portion of the disconnection region of the sensing layer.

5. The fabric connector of claim 4, further comprising:
a second yarn, formed with the conductive material, being configured to electrically connect to the first layer and the second layer.

6. The fabric connector of claim 5, wherein the first layer and the second layer have a same electric potential according to the second yarn.

7. The fabric connector of claim 1, wherein the insulating fabric is woven with insulating fibers, and material of the insulating fibers is one of pure polyurethane (PU) polymer and cotton.

8. The fabric connector of claim 1, wherein the conductive fabric is woven with conductive fibers and insulating fibers, material of the conductive fibers is stainless steel, and material of the insulating fibers is PU polymer.

9. The fabric connector of claim 1, wherein the conductive material of the first yarn is stainless steel fiber.
